(19) United States
(12) Patent Application Publication
(10) Pub. No.: US 2025/0264835 A1
(43) Pub. Date: Aug. 21, 2025

(54) IMAGE-PROCESSING APPARATUS

(71) Applicant: CANON KABUSHIKI KAISHA, Tokyo (JP)

(72) Inventors: YOSUKE HATA, Chiba (JP); KAZUHISA KOIZUMI, Chiba (JP)

(21) Appl. No.: 19/057,369

(22) Filed: Feb. 19, 2025

(30) Foreign Application Priority Data
Feb. 21, 2024 (JP) 2024-024826

(51) Int. Cl. G03G 15/00

(52) U.S. Cl. CPC G03G 15/5004; G03G 15/80

(57) ABSTRACT

There is provided an image-processing apparatus including: one or more heaters; a power supply unit including at least one direct current power supply, the power supply unit being configured to operate in one of a plurality of operation states having respective different total consumed powers; one or more drive circuits configured to drive the one or more heaters, respectively, using power supplied from the at least one direct current power supply; and a controller configured to control, on the basis of a driving state of the one or more heaters, the power supply unit to operate in an operation state selected such that a surplus of the total consumed power is reduced.

### BACKGROUND

### Field of the Disclosure

The present disclosure relates to an image-processing apparatus.

### Description of the Related Art

Image-processing apparatuses such as printers and scanners are exposed to various factors that cause the ambient temperature to fluctuate, depending on the region, season, or time of day, for example. If, for example, the temperature of an apparatus that has cooled down at night or in the morning then rises sharply in response to air-conditioning equipment in the office starting to operate, condensation will arise inside the apparatus, and moisture from this condensation will cause printing failures or operating failures. To prevent such failures due to temperature fluctuations, a technology is known in which a heater is installed in an apparatus to manage the temperature within the apparatus. Since it is necessary to run the heater even while the normal operations are not underway, the apparatus is generally connected to an alternating current (AC) commercial power supply to supply power to the heater. However, when power is supplied to the heater from an AC commercial power supply, the performance of the heater may differ depending on the installation environment of the apparatus.

Japanese Patent Laid-Open No. 2017-53954 discloses an image-forming apparatus that converts AC voltage from a commercial power supply into direct current (DC) voltage and supplies power to a heater with the DC voltage. With the image-forming apparatus of Japanese Patent Laid-Open No. 2017-53954, to prevent excessive power consumption when power is supplied from a DC power supply to a plurality of heaters, the supply of power from the DC power supply is controlled such that power is supplied only to no more than a predetermined number of heaters simultaneously.

### SUMMARY

According to an aspect, there is provided an image-processing apparatus including: one or more heaters; a power supply unit including at least one direct current power supply, the power supply unit being configured to operate in one of a plurality of operation states having respective different total consumed powers; one or more drive circuits configured to drive the one or more heaters, respectively, using power supplied from the at least one direct current power supply; and a controller configured to control, on the basis of a driving state of the one or more heaters, the power supply unit to operate in an operation state selected such that a surplus of the total consumed power is reduced.

Further features of the present disclosure will become apparent from the following description of exemplary embodiments (with reference to the attached drawings).

### BRIEF DESCRIPTION OF THE DRAWINGS

FIG. 1 is a schematic diagram illustrating an example of a configuration of a multifunction peripheral according to one or more aspects of the present disclosure.

FIG. 2 is a block diagram illustrating an example of an overall configuration of heater-related circuitry according to one or more aspects of the present disclosure.

FIG. 3 is a circuit diagram illustrating activation control of a PFC circuit.

FIG. 4 is an explanatory diagram illustrating an example of a UI provided for setting one or more heaters.

FIG. 5 is a circuit diagram illustrating an example of a detailed configurations of a switching circuit and a heater drive circuit illustrated in FIG. 2.

FIG. 6 is a mapping table that defines correspondence relationships between driving states of heaters and operation states of a power supply unit according to one or more aspects of the present disclosure.

FIG. 7 is a flowchart illustrating an example of a flow of state control processing according to one or more aspects of the present disclosure.

FIG. 8 is a block diagram illustrating an example of an overall configuration of heater-related circuitry according to one or more aspects of the present disclosure.

FIG. 9 is a mapping table that defines correspondence relationships between driving states of heaters and operation states of a power supply unit according to one or more aspects of the present disclosure.

FIG. 10 is a flowchart illustrating an example of a flow of state control processing according to one or more aspects of the present disclosure.

FIG. 11 is a flowchart illustrating an example of a detailed flow of heater power supply control processing illustrated in FIG. 10.

FIG. 12 is a block diagram illustrating an example of an overall configuration of heater-related circuitry according one or more aspects of the present disclosure.

FIG. 13 is a block diagram illustrating an example of an overall configuration of heater-related circuitry according to one or more aspects of the present disclosure.

FIG. 14 is a circuit diagram illustrating an example of a detailed configuration of a switch detection circuit illustrated in FIG. 13.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

The technology disclosed in Japanese Patent Laid-Open No. 2017-53954 does not take into account differences in the operation state of the DC power supply. For example, the power supply efficiency of a DC power supply depends on the operation state, such as activating/deactivating a power factor correction (PFC) circuit or a cooling fan, or turning on/off each of a plurality of DC power supplies that may be present. If a large amount of heating is required for the apparatus as a whole, it is necessary to operate the power supply circuit to a large extent to enhance the power supply efficiency. On the other hand, if only a small amount of heat is required (or heating is unnecessary), it is desirable to reduce the power consumption in the power supply circuit in order to meet the needs of energy conservation.

In light of the foregoing, some embodiments of the present disclosure aim to further improve energy conservation performance in an image-processing apparatus having a heater.

### 1. Apparatus Overview

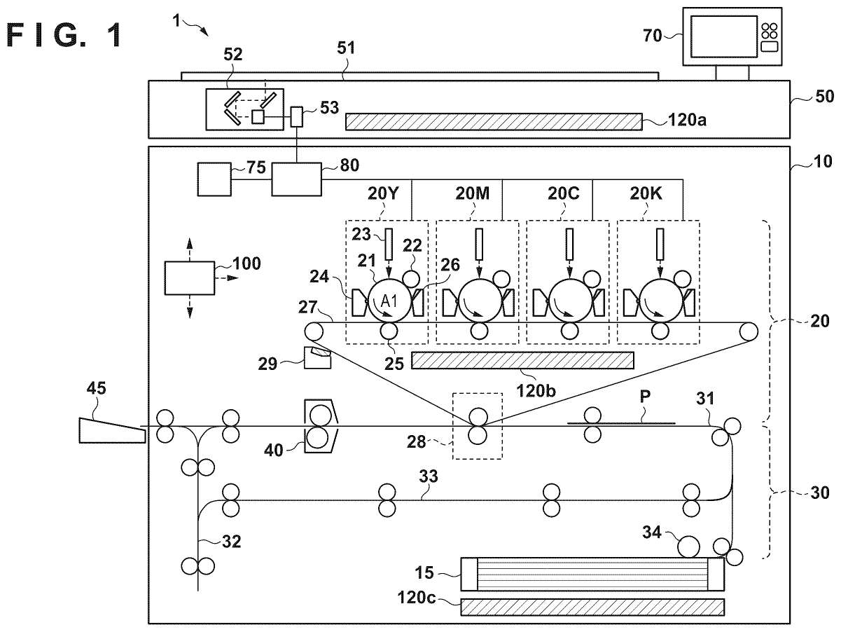

FIG. 1 is a schematic diagram illustrating an example of a configuration of a multifunction peripheral 1 according to an embodiment. Referring to FIG. 1, the multifunction peripheral 1 includes a printer unit 10, a scanner unit 50, an operation unit 70, a network interface (I/F) 75, a control unit 80, and a power supply unit 100. Each of the multifunction peripheral 1, the printer unit 10, and the scanner unit 50 is an example of an image-processing apparatus.

The printer unit 10 is an image-forming apparatus that forms an image on a sheet. The printer unit 10 includes a sheet feed cassette 15, an image-forming unit 20, a conveyance section 30, a fixing unit 40, and a discharge tray 45.

The image-forming unit 20 includes process units 25Y, 25M, 25C, and 25K, an intermediate transfer belt 27, a secondary transfer unit 28, and a belt cleaner 29. The process units 25Y, 25M, 25C, and 25K are units that form toner images of four color components, namely yellow, magenta, cyan, and black, using an electrophotographic method. In other words, the printer unit 10 according to the present embodiment is a color laser printer capable of printing full-color images. However, in another embodiment, the printer unit 10 may be a black-and-white printer, or a printer capable of printing images using another image-forming method, such as the ink jet method. The configurations of the process units 25Y, 25M, 25C, and 25K may be similar to each other, and thus the process unit 25Y will be described here as an example.

The process unit 25Y includes a photosensitive drum 21, a charger 22, a laser unit 23, a developer 24, a primary transfer roller 25, and a drum cleaner 26. The photosensitive drum 21 is an image carrier, and rotates in the direction of an arrow A₁ in the figure. The charger 22 electrically charges the surface of the photosensitive drum 21 to a uniform potential. The laser unit 23 has a semiconductor laser as a light source, and forms an electrostatic latent image on the surface of the photosensitive drum 21 by exposing the photosensitive drum 21 with a laser beam according to input image data. The developer 24 develops the electrostatic latent image to form a toner image by supplying toner to the electrostatic latent image on the surface of the photosensitive drum 21. The primary transfer roller 25 transfers the toner image (here, the yellow toner image) on the surface of the photosensitive drum 21 to the intermediate transfer belt 27 with an applied high transfer voltage. Magenta, cyan, and black toner images are similarly formed in the process units 25M, 25C, and 25K, respectively. Then, by transferring those toner images onto the yellow toner image on the intermediate transfer belt 27 sequentially, a full-color toner image is formed on the intermediate transfer belt 27. The intermediate transfer belt 27 conveys the toner image to the position of the secondary transfer unit 28.

The sheet feed cassette 15 is a container unit that contains a bundle of sheets. The conveyance section 30 includes conveyance paths 31, 32, and 33, a feed roller 34, and a plurality of conveyance rollers. The feed roller 34 picks up a sheet (also called “recording material”) P one by one from the sheet bundle contained in the sheet feed cassette 15 and feeds the sheet P to the conveyance path 31. When the sheet P conveyed along the conveyance path 31 reaches the secondary transfer position, the secondary transfer unit 28 transfers the toner image on the intermediate transfer belt 27 onto the sheet P with a secondary transfer roller to which a transfer voltage, which is a high voltage, is applied. The transfer voltage can be optimized according to the type of the sheet P. The conveyance section 30 may include a correction mechanism (not shown) that corrects skew in the sheet P on the conveyance path 31.

The drum cleaner 26 removes toner remaining on the surface of the photosensitive drum 21. The belt cleaner 29 removes toner remaining on the intermediate transfer belt 27.

The fixing unit 40 includes a fixing roller pair, and fixes the toner image onto the sheet P by heating and pressurizing the sheet P onto which the toner image has been transferred. The sheet P that has passed through the fixing unit 40 is discharged to the discharge tray 45.

When double-sided printing is performed, after exiting to the conveyance path 32, the direction of travel of the sheet P is reversed, and the sheet P enters a double-sided conveyance path 33. The sheet P returns to the conveyance path 31 having been flipped, and a toner image is transferred onto the back surface of the sheet P by the secondary transfer unit 28. The fixing unit 40 heats and pressurizes the sheet P again to fix that toner image onto the sheet P. The sheet P is then discharged to the discharge tray 45.

The scanner unit 50 is a reading apparatus that optically reads a document. The scanner unit 50 includes a document platform 51, an optical system 52, and an image sensor 53. The document to be read by the scanner unit 50 is placed on the document platform 51, or is fed sheet by sheet by an automatic document feeder (ADF) that is not shown in FIG. 1. The optical system 52 includes a light source, a mirror, and a lens. The light source irradiates the document with white light. Light reflected by the surface of the document is further reflected by one or more mirrors, passes through the lens, and is guided to the image sensor 53. The image sensor 53 includes color filters for three color components of R, G, and B, and generates read image data by converting the light of each color component into an image signal. The image sensor 53 outputs the read image data to the control unit 80.

The operation unit 70 provides a user interface for the multifunction peripheral 1 to interact with a user. Typically, the operation unit 70 may be a combination of a receiving unit that receives user inputs (e.g., instructions related to a job and various user settings) and a display unit that displays images or information, and may include a touch panel, buttons, switches, a keypad, and the like.

The network I/F 75 is an interface for the multifunction peripheral 1 to communicate with other apparatuses over a network. The network I/F 75 may be a wired interface or a wireless interface.

The control unit 80 controls the overall operations of the multifunction peripheral 1 described above. For example, when a print job is instructed to be executed, the control unit 80 controls the printer unit 10 to form an image on a sheet on the basis of input image data received from an external apparatus. When a scan job is instructed to be executed, the control unit 80 controls the scanner unit 50 to read a sheet, and saves the read image data in storage (not shown) or sends the read image data to a designated destination. When a copy job is instructed to be executed, the control unit 80 controls the scanner unit 50 to read a sheet, and controls the printer unit 10 to form an image on another sheet on the basis of the read image data.

The multifunction peripheral 1 further includes heaters 120a, 120b, and 120c. The heater 120a is disposed within the scanner unit 50, and heats the optical system 52 to prevent reading failures due to condensation. In the following descriptions, the heater 120a will also be referred to as a “scanner heater”. The heater 120b is disposed in the vicinity of the process units 25Y, 25M, 25C, and 25K, and heats the image-forming unit 20 (e.g., the photosensitive drum 21 and the intermediate transfer belt 27) to prevent image formation failures due to condensation. In the following descriptions, the heater 120b will also be referred to as a “drum heater”. The heater 120c is disposed below the sheet feed cassette 15, and heats the sheet feed cassette 15 and the sheet bundle within the cassette to prevent conveyance failures due to moisture being absorbed by the sheets. In the following descriptions, the heater 120c will also be referred to as a “cassette heater”.

In the following descriptions, the heaters 120a, 120b, and 120c will be collectively referred to as “heaters 120” by omitting the letters from the reference signs when there is no need to distinguish the heaters from each other. Although FIG. 1 illustrates an example in which the multifunction peripheral 1 includes three heaters 120 for heating the interior of the apparatus, the number of heaters 120 included in the multifunction peripheral 1 may be any number that is one or more.

Phenomena due to temperature fluctuations, such as condensation within the apparatus and moisture being absorbed by the sheets, can also occur when the multifunction peripheral 1 is not operating. Accordingly, it is necessary for the multifunction peripheral 1 to be configured such that power can be supplied to each of the heaters 120 during a sleep state, where the supply of power to the drive system is deactivated to conserve energy, and in a power off state. The power supply unit 100 functions as a DC power supply by converting AC voltage from a commercial power supply into DC voltage. The power supply unit 100 can supply power to each of the heaters 120 regardless of whether the multifunction peripheral 1 is powered on or off. In addition, when the multifunction peripheral 1 is powered on, the power supply unit 100 supplies power for operating the electronic circuitry to the control system of the multifunction peripheral 1, including the control unit 80. Furthermore, when the multifunction peripheral 1 is in a standby mode, which is a preparation stage for image-forming operations, and in a print mode (or a scanning mode), which is when the image-forming operations are being executed, the power supply unit 100 supplies power to the drive system of the multifunction peripheral 1 to enable the drive members to operate.

The present embodiment enables a user to set whether to activate each of the heaters 120 through a user interface (UI) provided by the operation unit 70 in order to make it possible to manage the temperature of the multifunction peripheral 1 flexibly in a variety of temperature environments. When more heaters 120 are active, the amount of heating required by the apparatus as a whole increases, and the power consumption increases. In this case, it is desirable to activate means for improving the power supply efficiency in the power supply unit 100. On the other hand, if some or all of the heaters 120 are not active and the amount of heating required by the apparatus as a whole is small, the power consumed by the means for improving the power supply efficiency in the power supply unit 100 itself is wasteful. In this case, it is desirable to reduce a surplus of power consumed by the power supply unit 100 in order to meet the needs of energy conservation. Accordingly, several practical examples for selectively switching the operation state of the power supply unit 100 on the basis of the driving state of the heaters will be described in the following sections.

### 2. First Practical Example

### <2-1. Example of Configuration of Heater-Related Circuitry>

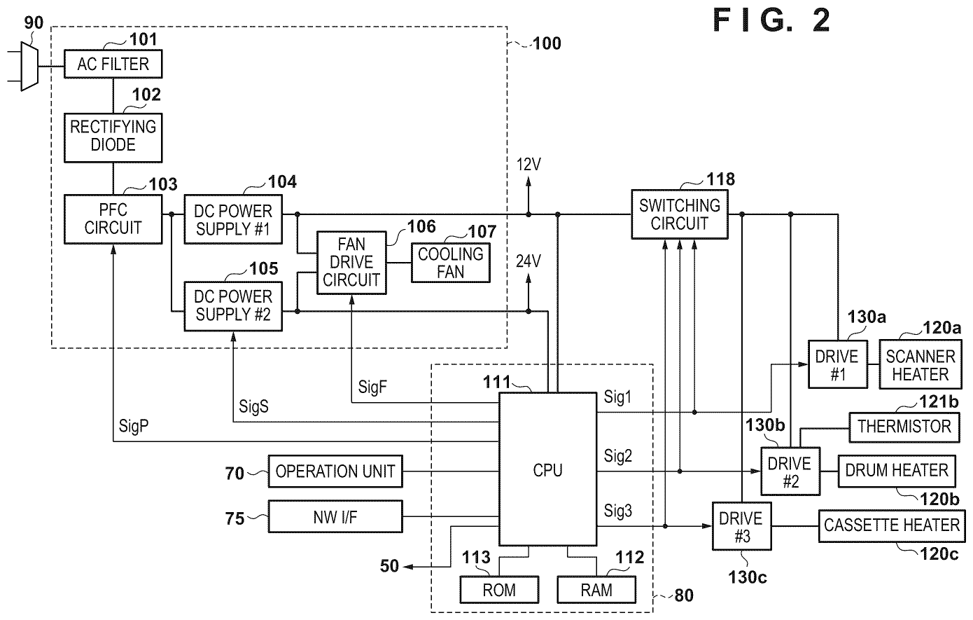

FIG. 2 is a block diagram illustrating an example of an overall configuration of heater-related circuitry according to a first practical example. In addition to the operation unit 70, the network I/F 75, the control unit 80, the power supply unit 100, and the heaters 120a, 120b, and 120c described with reference to FIG. 1, a power plug 90, a switching circuit 118, and heater drive circuits 130a, 130b, and 130c are illustrated in FIG. 2.

The power supply unit 100 includes an alternating current (AC) filter 101, a rectifying diode 102, a power factor correction (PFC) circuit 103, a first direct current (DC) power supply 104, a second DC power supply 105, a fan drive circuit 106, and a cooling fan 107. The control unit 80 includes a Central Processing Unit (CPU) 111, a Random Access Memory (RAM) 112, and a Read-Only Memory (ROM) 113.

The power plug 90 is connected to a commercial power supply, which is an AC power supply. The AC filter 101 removes noise by filtering the power from the commercial power supply received through the power plug 90. The rectifying diode 102 rectifies the AC power passing through the AC filter 101. The PFC circuit 103 corrects the power factor of the power input from the rectifying diode 102. For example, the PFC circuit 103 can correct the power factor of the power by suppressing harmonic components of current flowing through the circuit to correct distortion in the waveform. In the present practical example, the PFC circuit 103 operates in accordance with a PFC control signal SigP input from the CPU 111. When the PFC circuit 103 is active, the power following the power factor correction is supplied to the first DC power supply 104 and the second DC power supply 105. When the PFC circuit 103 is inactive, the power for which the power factor has not been corrected is supplied to the first DC power supply 104 and the second DC power supply 105.

FIG. 3 is a circuit diagram illustrating activation control of the PFC circuit 103, which is based on the PFC control signal SigP. In the example illustrated in FIG. 3, the PFC circuit 103 includes a photocoupler 115, a switch 116, and a PFC control unit 117. The photocoupler 115 is constituted by a secondary-side light-emitting element and a primary-side light-receiving element. When the signal value of the PFC control signal SigP input from the CPU 111 indicates that the PFC circuit is to be active, the photocoupler 115 turns the switch 116 on such that an operating power of 3.3V is output to the PFC control unit 117. As a result, the power factor of the power supply unit 100 is corrected by the PFC control unit 117 activating the PFC circuit 103. When the signal value of the PFC control signal SigP indicates that the PFC circuit is to be inactive, the photocoupler 115 causes the switch 116 to shut off the supply of operating power to the PFC control unit 117. The PFC circuit 103 is deactivated as a result. Returning to FIG. 2, the first DC power supply 104 generates DC power by converting the AC voltage of power supplied from the PFC circuit 103 into DC voltage. In the present practical example, the voltage of the DC power generated by the first DC power supply 104 is 12 V. This DC power is the power supplied to the heaters 120a, 120b, and 120c. The DC power from the first DC power supply 104 is also output to the fan drive circuit 106 and the control unit 80.

The second DC power supply 105 generates DC power by converting the AC voltage of the power supplied from the PFC circuit 103 into DC voltage. In the present practical example, the voltage of the DC power generated by the second DC power supply 105 is 24 V. This DC power is supplied to the fan drive circuit 106 in parallel with the DC power from the first DC power supply 104, and further to the control unit 80 and the drive system (not shown) of the multifunction peripheral 1. The second DC power supply 105 is activated in response to a power control signal SigS input from the CPU 111. When the second DC power supply 105 is inactive, no power is supplied to the drive system of the multifunction peripheral 1.

The cooling fan 107 is a cooling unit that cools the first DC power supply 104 and the second DC power supply 105 of the power supply unit 100. The fan drive circuit 106 drives the cooling fan 107 using the DC power supplied from the first DC power supply 104 or the second DC power supply 105. The fan drive circuit 106 and the cooling fan 107 are activated in response to a fan control signal SigF input from the CPU 111 to the fan drive circuit 106.

The CPU 111 controls execution of jobs in the multifunction peripheral 1, as described above with respect to the control unit 80. The RAM 112 provides a temporary storage area for operations by the CPU 111. The ROM 113 stores computer programs to be executed by the CPU 111. Furthermore, in the present practical example, the CPU 111 also functions as a controller that controls the supply of power from the power supply unit 100 to the one or more heaters 120 on the basis of user settings received through the UI.

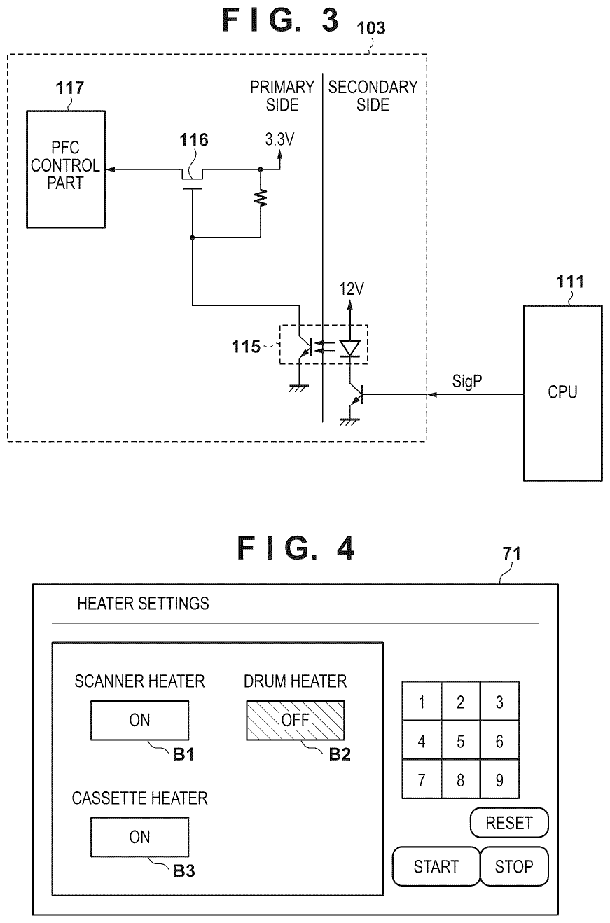

FIG. 4 illustrates a heater settings screen 71 as an example of the UI provided by the operation unit 70 for setting each of the heaters 120. The heater settings screen 71 illustrated in FIG. 4 includes a first button B1, a second button B2, and a third button B3. The first button B1 is a button for setting the driving state of the scanner heater 120a. The user can activate or deactivate the scanner heater 120a by operating the first button B1. The second button B2 is a button for setting the driving state of the drum heater 120b. The user can activate or deactivate the drum heater 120b by operating the second button B2. The third button B3 is a button for setting the driving state of the cassette heater 120c. The user can activate or deactivate the cassette heater 120c by operating the third button B3. In the example in FIG. 4, the scanner heater 120a and the cassette heater 120c are set to be active, and the drum heater 120b is set to be inactive. The CPU 111 outputs drive signals Sig1, Sig2, and Sig3 to the heater drive circuits 130a, 130b, and 130c, respectively, on the basis of the user settings received in this manner. Note that instead of the operation unit 70 of the multifunction peripheral 1, a UI similar to that of the heater settings screen 71 may be provided to the user through a display in another apparatus that communicates with the multifunction peripheral 1.

Returning to FIG. 2, the switching circuit 118 is a switching means that opens and closes a power supply path from the first DC power supply 104 to each of the heaters 120. When all of the drive signals Sig1, Sig2, and Sig3 output from the CPU 111 to the heater drive circuits 130a, 130b, and 130c, respectively, indicate that the corresponding heater is to be deactivated, the switching circuit 118 shuts off the supply of the DC power of 12V from the first DC power supply 104. When one or more of the drive signals Sig1, Sig2, and Sig3 indicate that the corresponding heater is to be activated, the switching circuit 118 causes the first DC power supply 104 to supply the heater drive circuits 130a, 130b, and 130c with the DC power.

The heater drive circuits 130a, 130b, and 130c are drive means for driving the heaters 120a, 120b, and 120c, respectively, using the power supplied from at least one of the DC power supplies of the power supply unit 100. When the drive signal Sig1 input from the CPU 111 indicates that the scanner heater 120a is to be activated, the heater drive circuit 130a drives the scanner heater 120a using the DC power supplied from the first DC power supply 104. When the drive signal Sig2 input from the CPU 111 indicates that the drum heater 120b is to be activated, the heater drive circuit 130b drives the drum heater 120b using the DC power supplied from the first DC power supply 104. When the drive signal Sig3 input from the CPU 111 indicates that the cassette heater 120c is to be activated, the heater drive circuit 130c drives the cassette heater 120c using the DC power supplied from the first DC power supply 104. In other words, in the present practical example, the heater drive circuits 130a, 130b, and 130c drive the corresponding heaters 120a, 120b, and 120c in accordance with the user settings accepted by the operation unit 70.

Each of the heaters 120 has a resistive heating element that produces heat in response to current flowing therein. The resistance value of the resistive heating element is selected as appropriate at the design stage such that a desired amount of heat is produced in accordance with the supplied power. Each of the heaters 120 may have a temperature adjustment circuit for keeping the temperature of the heated members at or near a target temperature, or for preventing overheating. In the example illustrated in FIG. 2, a thermistor 121b is disposed in the vicinity of the drum heater 120b. The resistance value of the thermistor 121b changes depending on the temperature inside the image-forming unit 20. Once the temperature of the heated members detected by the thermistor 121b has reached a given threshold, the heater drive circuit 130b does not drive the drum heater 120b, even if the drive signal Sig2 indicates that the drum heater 120b is to be activated. Similar temperature adjustment circuits may of course be provided for the scanner heater 120a and the cassette heater 120c.

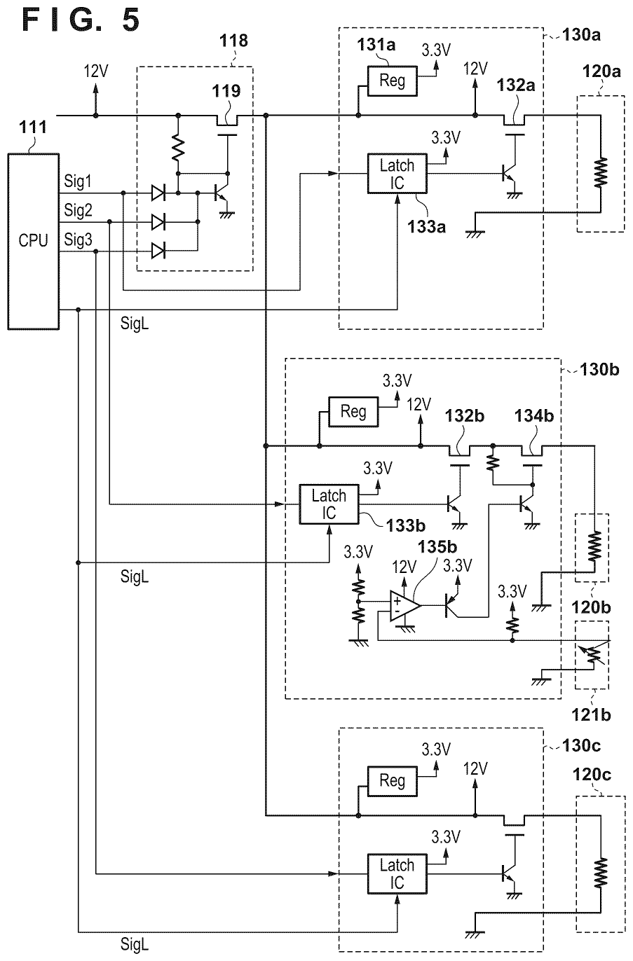

FIG. 5 illustrates an example of a detailed configurations of the switching circuit 118 and the heater drive circuits 130a, 130b, and 130c described above. In the example illustrated in FIG. 5, the switching circuit 118 includes a switch 119. When one or more of the drive signals Sig1, Sig2, and Sig3 are on, the switch 119 closes the power supply path of the DC power of 12V, which allows the DC power to be supplied to the heater drive circuits 130a, 130b, and 130c.

In the heater drive circuit 130a, a series regulator 131a steps down the voltage of the DC power to be supplied to the heater drive circuit 130a from 12V to 3.3V, and supplies the DC power of 3.3 Vto each circuit element of the heater drive circuit 130a. When the drive signal input through a transistor from a latch circuit 133a indicates “on”, a switch 132a supplies the DC power of 12V to the scanner heater 120a. The latch circuit 133a receives the drive signal Sig1 and a latch enable signal SigL from the CPU 111. The following table is a truth table for the latch circuits of the heater drive circuits 130a to 130c.

TABLE 1

| Heater drive signal | Latch enable signal | |
|---|---|---|
| SigX (X = 1, 2, 3) | SigL | Latch output |
| Low | High | Low |
| High | High | High |
| Any | Low | Hold |

### Truth Table for Latch Circuits of Heater Drive Circuits

According to the above truth table, when the latch enable signal SigL indicates “High”, the latch circuit 133a outputs the value of the drive signal Sig1 input from the CPU 111 to the transistor in the following stage. When the latch enable signal SigL indicates “Low”, the latch circuit 133a holds the value of the drive signal Sig1 input the previous time, and outputs the held value to the transistor in the following stage. By having the latch circuit 133a hold and output the value of the drive signal Sig1 in this manner, the scanner heater 120a can remain active using the DC power supplied from the first DC power supply 104, even if the CPU 111 stops operating and the input of the drive signal Sig1 is interrupted.

The heater drive circuit 130c is configured in the same manner as the heater drive circuit 130a.

The heater drive circuit 130b is also configured in the same manner as the heater drive circuit 130a. However, the heater drive circuit 130b further includes, in the power supply path of the DC power of 12V, a switch 134b in the stage following a switch 132b turned on and off by the output of a latch circuit 133b. Once the temperature of the heated members detected by the thermistor 121b has risen and the voltage across both ends of the thermistor 121b reaches a threshold voltage of a comparator 135b, the switch 134b shuts off the power supply path from the switch 132b to the drum heater 120b. Once the temperature of the heated members falls, the switch 134b resumes the supply of power from the switch 132b to the drum heater 120b.

### <2-2. Control of Operation State of Power Supply Unit>

As described above, the multifunction peripheral 1 has one or more heaters 120 for heating the interior of the apparatus. Each of the heaters 120 is driven using power supplied from at least one DC power supply (the first DC power supply 104, in the present practical example) of the power supply unit 100. Meanwhile, the power supply unit 100 includes the following circuits, which are activated in response to the control of the control unit 80 and consume power:
the PFC circuit 103
the fan drive circuit 106 and the cooling fan 107
the second DC power supply 105

The operation state of the power supply unit 100 can be categorized into several states depending on whether these circuits are active, and the total consumed power of the power supply unit 100 is different in each operation state. The PFC circuit 103 corrects the power factor in the power supply unit 100 and increases the power capacity of the multifunction peripheral 1, but it does not necessarily need to activate the PFC circuit 103 when the required power amount in the multifunction peripheral 1 is low. The cooling fan 107 ensures a stable power supply by cooling the DC power supplies of the power supply unit 100, but when the power amount used in the multifunction peripheral 1 is low, the heat produced by the power supply unit 100 is also low, and therefore it does not necessarily need to activate the cooling fan 107. Accordingly, on the basis of the driving states of the heaters 120, the CPU 111 selects an operation state of the power supply unit 100 such that the surplus of the total consumed power of the power supply unit 100 is reduced, and causes the power supply unit 100 to operate in the selected operation state.

In the present practical example, the control unit 80 is assumed to have a memory (e.g., the ROM 113) that stores, in advance, the power amount required when driving each of the heaters 120. For the heaters 120 set to be driven, the CPU 111 determines the required power amount to be supplied from the power supply unit 100 by totaling the stored power amounts. When determining the required power amount, the CPU 111 may take into account the operation mode of the multifunction peripheral 1 (e.g., the drive system consumes more power in the standby mode and the print mode) in addition to the driving states of the heaters 120. Then, on the basis of a comparison between the determined required power amount and a predetermined threshold, the CPU 111 selects an operation state in which the power supply unit 100 is to be operated.

As a first example, candidates for the operation states of the power supply unit 100 include a first state, in which the PFC circuit 103 is active and the total consumed power of the power supply unit 100 is a first power value, and a second state, in which the PFC circuit 103 is inactive and the total consumed power of the power supply unit 100 is a second power value. The second power value is lower than the first power value. When the required power amount determined on the basis of the driving states of the heaters 120a to 120c is greater than a predetermined power threshold, the CPU 111 selects the first state, so that the required power amount is covered sufficiently, and activates the PFC circuit 103. On the other hand, when the required power amount determined is lower than the power threshold, the CPU 111 selects the second state and deactivates the PFC circuit 103 to reduce a surplus of power consumption.

As a second example, candidates for the operation states of the power supply unit 100 include a first state, in which the cooling fan 107 is active and the total consumed power of the power supply unit 100 is a first power value, and a second state, in which the cooling fan 107 is inactive and the total consumed power of the power supply unit 100 is a second power value. The second power value is lower than the first power value. Note that the first power value and the second power value here may be different from the corresponding values in the first example described above. When the required power amount determined on the basis of the driving states of the heaters 120a to 120c is greater than a predetermined power threshold, the CPU 111 selects the first state, so that the required power amount is covered sufficiently, and activates the cooling fan 107. On the other hand, when the required power amount determined is lower than the power threshold, the CPU 111 selects the second state and deactivates the cooling fan 107 to reduce a surplus of power consumption.

Of course, it is also conceivable to combine the first example and the second example. For example, the CPU 111 may compare a required power amount P_{REQ} determined on the basis of the driving states of the heaters 120a to 120c with a first power threshold TH₁ and a second power threshold TH₂, and select an operation state of the power supply unit 100 as follows. Here, it is assumed that TH₁<TH₂.
If P_{REQ}<TH₁, then both the PFC circuit and the cooling fan are deactivated
If TH₁≤P_{REQ} <TH₂, then only one of the PFC circuit and the cooling fan is activated.
If TH₂≤P_{REQ}, then both the PFC circuit and the cooling fan are activated

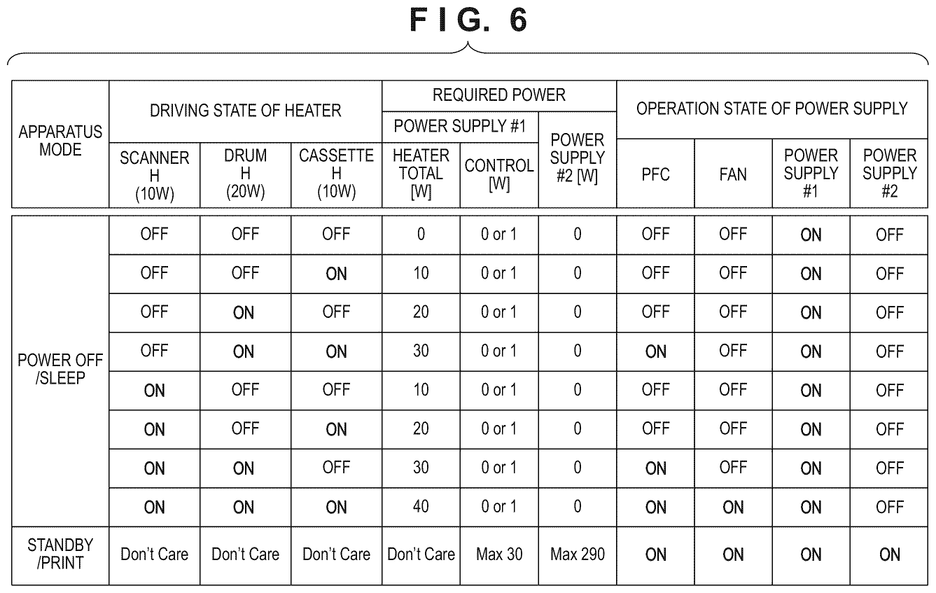

FIG. 6 is a mapping table that defines correspondence relationships between the driving states of the heaters 120 and the operation states of the power supply unit 100 according to the present practical example. The leftmost column of the mapping table indicates the operation mode of the multifunction peripheral 1. The operation mode of the multifunction peripheral 1 is one of “power off”, “sleep”, “standby”, and “print”. “Power off” is a state in which all functions of the multifunction peripheral 1 are inactive. “Sleep” is a state in which only some functions of the control system of the multifunction peripheral 1 are active (e.g., receiving queries through the network I/F and responding thereto). “Standby” is a state in which a job is not being executed, but all functions of the multifunction peripheral 1 are active or can be activated immediately. “Print” is a state in which a job is being executed in the multifunction peripheral 1.

The second to fourth columns from the left in the mapping table represent the driving state (“on” or “off”) of the scanner heater 120a, the drum heater 120b, and the cassette heater 120c, respectively. The two driving states of the three heaters 120 can be combined for a total of eight driving states. As an example, the scanner heater 120a in “on” state consumes 10 W of power as a rated power. The drum heater 120b in “on” state consumes 20 W of power as a rated power. Although the supply of power to the drum heater 120b may be shut off due to the actions of the temperature adjustment circuit even when the driving state thereof is “on”, the actions of the temperature adjustment circuit are assumed to be ignored when determining the power amount. The cassette heater 120c in “on” state consumes 10 W of power as a rated power.

The fifth column in the mapping table indicates the total value of the required power amount, corresponding to the driving states of the heaters 120a to 120c in each row. For example, the total value of the required power amount in the eighth row, where the driving states of all the heaters 120a to 120c are “on”, is 10+20+10=40 [W]. The sixth column in the mapping table indicates the power amount supplied from the first DC power supply 104 to the control system, corresponding to the operation mode of the multifunction peripheral 1 in each row. Regardless of the driving states of the heaters 120a to 120c, before being powered on, the required power amount of the control system is 0 [W], and in the sleep mode, the required power amount of the control system is 1 [W]. In the standby mode and the print mode, the required power amount of the control system is a maximum of 30 [W] (but in reality, the power consumption varies depending on the type of control performed). The seventh column in the mapping table indicates the power amount supplied from the second DC power supply 105, corresponding to the operation mode of the multifunction peripheral 1 in each row. Regardless of the driving states of the heaters 120a to 120c, in the power off and sleep modes, the second DC power supply 105 is inactive, and the required power amount is therefore 0 [W]. In the standby mode and the print mode, power is supplied from the second DC power supply 105 to the drive system, and the required power amount thereof is a maximum of 290 [W] (but in reality, the power consumption varies depending on the type of operations performed).

The eighth to eleventh columns in the mapping table indicate how the CPU 111 selects an operation state of the power supply unit 100 with respect to the driving states of the heaters 120a to 120c in each row. Specifically, the eighth column indicates whether the PFC circuit 103 is on or off. In the example illustrated in FIG. 6, the CPU 111 activates the PFC circuit 103 when the total value of the required power amounts of the heaters 120a to 120c is 30 W or higher, and deactivates the PFC circuit 103 when the total value of the required power amounts is less than 30 W. This threshold of 30 W can correspond to the first power threshold TH₁ mentioned above.

The ninth column indicates whether the cooling fan 107 is on or off. In the example illustrated in FIG. 6, the CPU 111 activates the cooling fan 107 when the total value of the required power amounts of the heaters 120a to 120c is 40 W or higher, and deactivates the cooling fan 107 when the total value of the required power amounts is less than 40 W. This threshold of 40 W can correspond to the second power threshold TH₂ mentioned above.

The tenth column indicates whether the first DC power supply 104 is on or off. In the present practical example, the first DC power supply 104 is always connected to the commercial power supply, and thus the tenth column indicates “on” in all rows. Note that the power that the first DC power supply 104 is capable of outputting depends on the operation states of the PFC circuit 103 and the cooling fan 107.

The eleventh column indicates whether the second DC power supply 105 is on or off. In the present practical example, the second DC power supply 105 is only activated in the standby mode and the print mode, and thus the eleventh column indicates “on” only in the bottom row, and “off” in the remaining rows corresponding to the power off and sleep modes.

As an example, when both the PFC circuit 103 and the cooling fan 107 are inactive, the maximum value of the power that the first DC power supply 104 is capable of outputting is less than 30 W. When only the PFC circuit 103 is active, the maximum value of the power that the first DC power supply 104 is capable of outputting is greater than 30 W and less than 40 W. When both the PFC circuit 103 and the cooling fan 107 are active, the maximum value of the power that the first DC power supply 104 is capable of outputting reaches 70 W. The mapping table in FIG. 6 assumes that the power supply unit 100 has such performance.

In the standby mode and the print mode, by activating both the PFC circuit 103 and the cooling fan 107 and further activating the second DC power supply 105, a sufficient amount of power can be stably supplied to the one or more heaters, the control system, and the drive system. On the other hand, if the PFC circuit 103 and the cooling fan 107 are active in the power-off or sleep mode when several of the heaters are set to be inactive, the power capacity of the power supply unit 100 is much greater than the required power amount. This means that at least some of the power consumed by the PFC circuit 103, the fan drive circuit 106, and the cooling fan 107 is wasted. In the present practical example, one or both of the PFC circuit 103 and the cooling fan 107 are deactivated dynamically in accordance with the mapping table described above (or in accordance with a comparison of the required power amount with the power threshold). This makes it possible to eliminate wasteful power consumption and optimize the power consumption of the multifunction peripheral 1.

<2-3. Flow of Processing>

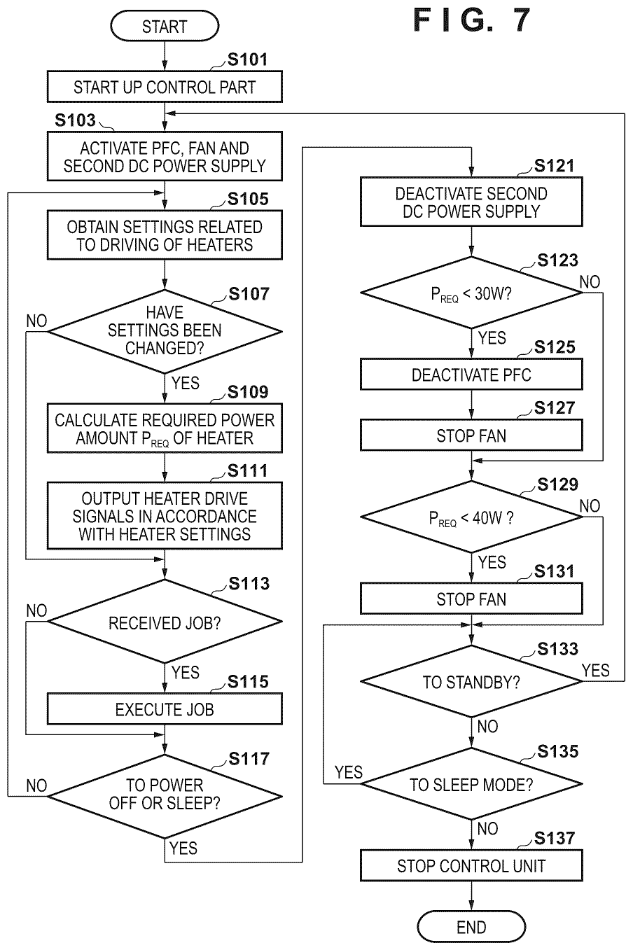

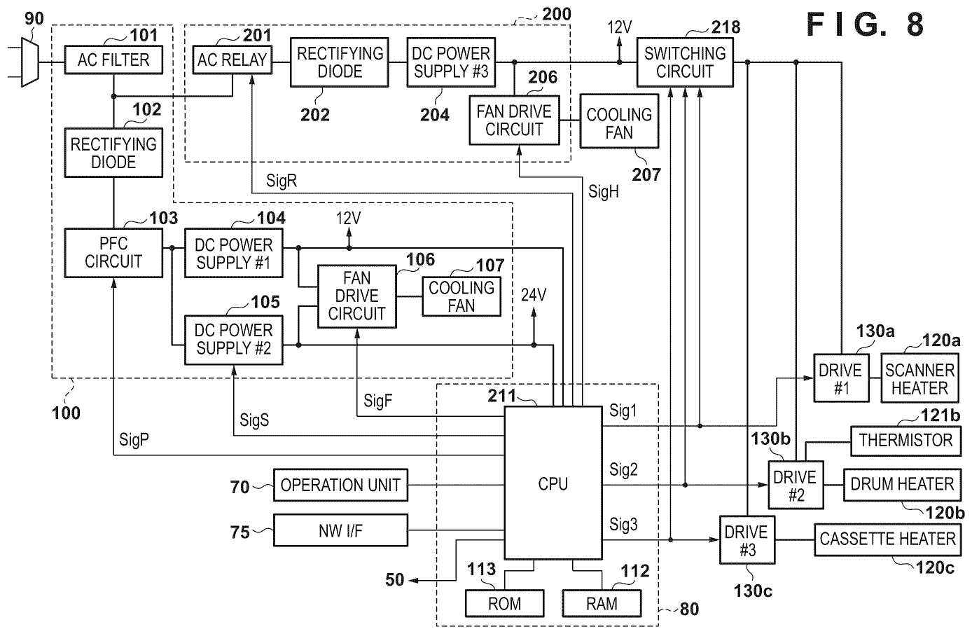

FIG. 7 is a flowchart illustrating an example of a flow of state control processing that can be executed by the control unit 80 (e.g., the CPU 111) to control a power supply state in the multifunction peripheral 1 according to the present practical example. In the following descriptions, the processing steps will be abbreviated as “S”.

The state control processing illustrated in FIG. 7 is started in response to the multifunction peripheral 1 being powered on. First, in step S101, the control unit 80 starts up, and commences the operations. In step S103, the control unit 80 outputs the PFC control signal SigP to the PFC circuit 103 to activate the PFC circuit 103. The control unit 80 also outputs the fan control signal SigF to the fan drive circuit 106 to start driving the cooling fan 107. The control unit 80 furthermore outputs the power control signal SigS to the second DC power supply 105 to activate the second DC power supply 105.

Next, in step S105, the control unit 80 obtains user settings related to the driving of the heaters 120a to 120c (called “heater settings” hereinafter), which are received through the UI of the operation unit 70. Next, in step S107, the control unit 80 determines whether the heater settings have been changed since the previous calculation of the required power amount P_{REQ}. If the heater settings have been changed, the sequence moves to step S109.

In step S109, the control unit 80 calculates the required power amount P_{REQ} on the basis of the heater settings obtained in step S105. For example, the control unit 80 can calculate the required power amount P_{REQ} by totaling the power amounts defined in advance for the heaters 120 set to be active. Then, in step S111, the control unit 80 outputs the drive signals Sig1, Sig2, and Sig3 to the heater drive circuits 130a, 130b, and 130c, respectively, in accordance with the heater settings.

If the heater settings have not been changed in step S107, steps S109 and S111 are skipped. In this case, the heater drive circuits 130a, 130b, and 130c drive the corresponding heaters 120a, 120b, and 120c in accordance with the drive signal values held in the respective latch circuits.

Next, in step S113, the control unit 80 stands by to receive a job. The operation mode of the multifunction peripheral 1 is the standby mode from step S105 to step S113. When a job is received in the standby mode, in step S115, the control unit 80 controls one or both of the printer unit 10 and the scanner unit 50 to execute the received job. The operation mode of the multifunction peripheral 1 in step S115 is the print mode (or the scanning mode, if a scan job is executed).

Next, in step S117, the control unit 80 determines whether the multifunction peripheral 1 should be powered off or transition to the sleep mode. For example, if an operation for turning the power off has been detected in the operation unit 70, the multifunction peripheral 1 is powered off. If an operation instructing a transition to the sleep mode is detected, or a predetermined length of time has passed without any operations being performed, the multifunction peripheral 1 transitions to the sleep mode. If the multifunction peripheral 1 is powered off or transitions to the sleep mode, the sequence moves to step S121. If the multifunction peripheral 1 remains in the standby mode, the sequence returns to step S105.

In step S121, the control unit 80 outputs the power control signal SigS to the second DC power supply 105 to deactivate the second DC power supply 105. The subsequent processing branches on the basis of a comparison between the required power amount P_{REQ} calculated in step S109 and the two power thresholds TH₁ and TH₂. Here, it is assumed that the first power threshold TH₁₌₃₀ [W] and the second power threshold TH₂₌₄₀ [W].

If the required power amount P_{REQ} is lower than the first power threshold TH₁ (P_{REQ} <30 W; step S123-YES), in step S125, the control unit 80 outputs the PFC control signal SigP to the PFC circuit 103 to deactivate the PFC circuit 103. Additionally, in step S127, the control unit 80 outputs the fan control signal SigF to the fan drive circuit 106 to stop the driving of the cooling fan 107.

If the required power amount P_{REQ} is greater than the first power threshold TH₁ and lower than the second power threshold TH₂ (30 W≤P_{REQ} <40 W; step S129-YES), in step S131, the control unit 80 outputs the fan control signal SigF to the fan drive circuit 106 to stop the driving of the cooling fan 107.

If the required power amount P_{REQ} is greater than the second power threshold TH₂ (40 W<P_{REQ}), the PFC circuit 103 and the cooling fan 107 are not deactivated.

Next, in step S133, the control unit 80 determines whether the multifunction peripheral 1 should be returned to the standby mode. For example, if any operation is detected in the operation unit 70, the multifunction peripheral 1 returns to the standby mode from the sleep mode. In this case, the sequence returns to step S103. If the condition for returning to the standby mode is not satisfied, in step S135, the control unit 80 determines whether the multifunction peripheral 1 should remain in the sleep mode or should be powered off. If the multifunction peripheral 1 should remain in the sleep mode, the sequence returns to step S133. If the multifunction peripheral 1 should be powered off, the sequence moves to step S137. In step S137, the control unit 80 stops operating, and the multifunction peripheral 1 turns into a state in which no power is supplied. The flowchart illustrated in FIG. 7 assumes the relationships between the driving states of the heaters 120a, 120b, and 120c and the operation states of the power supply unit 100 defined in the mapping table in FIG. 6. However, the relationships between the driving states of the one or more heaters 120 and the operation states of the power supply unit 100 are not limited to the examples described above. For example, the values of the first power threshold TH₁ and the second power threshold TH₂ may be different from those in the example described above. An operation state in which only the cooling fan 107 is active may be employed instead of an operation state in which only the PFC circuit 103 is active.

In addition to the driving states of the heaters 120, the control unit 80 may determine the required power amount P_{REQ} on the basis of the power consumption of components, aside from the heaters, that depend on the operation mode of the multifunction peripheral 1. In particular, when there is a significant difference in the power consumption of one or both of the control system and the drive system from operation mode to operation mode, adding such a difference to the determination of the required power amount makes it possible to more accurately determine the surplus of the total consumed power and appropriately select an operation state of the power supply unit.

Although an example in which whether to activate each circuit in the power supply unit 100 is determined on the basis of a comparison of the required power amount and the power threshold has been described here, the technology according to the present disclosure is not limited to this example. For example, the control unit 80 may store a mapping table associating each driving state of the heaters with the corresponding operation state of the power supply unit 100 in advance in the memory, and determine an operation state of the power supply unit 100 directly from the heater settings, without calculating the required power amount, by referring to the mapping table in the memory.

The control unit 80 may determine an operation state of the power supply unit 100 on the basis of the number of heaters to be driven. As an example, the control unit 80 may cause the power supply unit 100 to operate in a first state when a first number of heaters are to be driven, and may cause the power supply unit 100 to operate in a second state when a second number of heaters, smaller than the first number, are to be driven. As another example, the control unit 80 may cause the power supply unit 100 to operate in a first state when at least one heater is to be driven, and may cause the power supply unit 100 to operate in a second state when no heaters are to be driven. Here, the first state is a state in which the total consumed power of the power supply unit 100 is a first power value, and the second state is a state in which the total consumed power of the power supply unit 100 is a second power value lower than the first power value.

Although the first practical example described the multifunction peripheral 1 (and more generally, the image-processing apparatus) as including three heaters 120a, 120b, and 120c, the technology according to the present disclosure can also be applied when the image-processing apparatus includes only one heater. In addition, the technology according to the present disclosure can also be applied when the image-processing apparatus includes a plurality of heaters but only one of those heaters is subject to the determination of the driving state. For example, the controller of the image-processing apparatus may cause the power supply unit to operate in a first state, in which the total consumed power is a first power value, when one heater is to be operated, and may cause the power supply unit to operate in a second state, in which the total consumed power is a lower second power value, when the heater is not to be operated.

### 3. Second Practical Example

### <3-1. Example of Configuration of Heater-Related Circuitry>

FIG. 8 is a block diagram illustrating an example of an overall configuration of heater-related circuitry according to a second practical example. The configuration of the circuitry illustrated in FIG. 8 differs from the configuration of the circuitry according to the first practical example and illustrated in FIG. 2 in that a heater power supply unit 200 and an additional cooling fan 207 are provided. In addition, in the present practical example, the CPU 111 and the switching circuit 118 according to the first practical example are replaced with a CPU 211 and a switching circuit 218.

The heater power supply unit 200 is a circuit that generates DC power to be supplied to the heaters 120a, 120b, and 120c. The heater power supply unit 200 includes an AC relay 201, a rectifying diode 202, a third DC power supply 204, and a fan drive circuit 206.

AC power passing through the AC filter 101 of the power supply unit 100 is supplied to the AC relay 201. In the present practical example, the AC relay 201 is activated in response to a power control signal SigR input from the CPU 211. When the AC relay 201 is active, the power from the AC filter 101 is relayed to the rectifying diode 202. When the AC relay 201 is inactive, the supply of power to the rectifying diode 202 and subsequent circuits is shut off.

The rectifying diode 202 rectifies the AC power supplied via the AC relay 201. The third DC power supply 204 generates DC power by converting the AC voltage rectified by the rectifying diode 202 into DC voltage. In the present practical example, the voltage of the DC power generated by the third DC power supply 204 is 12 V. This DC power is the power supplied to the heaters 120a, 120b, and 120c. The DC power from the third DC power supply 204 is also output to the fan drive circuit 206.

The cooling fan 207 is a cooling unit that cools the third DC power supply 204 of the heater power supply unit 200. The fan drive circuit 206 drives the cooling fan 207 using the DC power supplied from the third DC power supply 204. The fan drive circuit 206 and the cooling fan 207 is activated in response to a fan control signal SigH input from the CPU 211 to the fan drive circuit 206.

The CPU 211 controls execution of jobs in the multifunction peripheral 1 in the same manner as the CPU 111 according to the first practical example. Furthermore, in the present practical example, the CPU 211 also functions as a controller that controls the supply of power from the heater power supply unit 200 to the one or more heaters 120 on the basis of user settings received through a UI such as that described with reference to FIG. 4.

The switching circuit 218 is a switching means that opens and closes a power supply path from the third DC power supply 204 to each of the heaters 120. When all of the drive signals Sig1, Sig2, and Sig3 output from the CPU 211 to the heater drive circuits 130a, 130b, and 130c, respectively, indicate that the corresponding heater is to be deactivated, the switching circuit 218 shuts off the supply of the DC power of 12V from the third DC power supply 204. When one or more of the drive signals Sig1, Sig2, and Sig3 indicate that the corresponding heater is to be activated, the switching circuit 218 causes the third DC power supply 204 to supply the heater drive circuits 130a, 130b, and 130c with the DC power. The detailed configurations of the switching circuit 218 and the heater drive circuits 130a, 130b, and 130c may be similar to the configurations described with reference to FIG. 5 in the first practical example.

### <3-2. Control of Operation State of Power Supply Unit>

Each of the heaters 120 is driven using power supplied from at least one DC power supply (the third DC power supply 204, in the present practical example) of the heater power supply unit 200. Meanwhile, the heater power supply unit 200 includes the following circuits, which are activated in response to the control of the control unit 80 and consume power:
the fan drive circuit 206 (and the cooling fan 207)
the third DC power supply 204
   The operation state of the heater power supply unit 200 can be categorized into several states depending on whether these circuits are active, and the total consumed power of the heater power supply unit 200 is different in each operation state. Accordingly, on the basis of the driving states of the heaters 120, the CPU 211 selects an operation state of the heater power supply unit 200 such that a surplus of the total consumed power of the heater power supply unit 200 is reduced, and causes the heater power supply unit 200 to operate in the selected operation state.

In the present practical example, the control unit 80 is assumed to have a memory that stores, in advance, the power amount required when driving each of the heaters 120. For the heaters 120 set to be driven, the CPU 211 determines the required power amount to be supplied from the heater power supply unit 200 by totaling the stored power amounts. When determining the required power amount, the CPU 211 may take into account the operation mode of the multifunction peripheral 1 in addition to the driving states of the heaters 120. Then, on the basis of a comparison between the determined required power amount and a predetermined threshold, the CPU 211 selects an operation state in which the heater power supply unit 200 is to be operated.

As a first example, candidates for the operation states include a first state, in which the cooling fan 207 is active and the total consumed power of the heater power supply unit 200 is a first power value, and a second state, in which the cooling fan 207 is inactive and the total consumed power of the heater power supply unit 200 is a second power value. The second power value is lower than the first power value. When the required power amount determined on the basis of the driving states of the heaters 120a to 120c is greater than a predetermined power threshold, the CPU 211 selects the first state, so that the required power amount is covered sufficiently, and activates the cooling fan 207. On the other hand, when the required power amount determined is lower than the power threshold, the CPU 211 selects the second state and deactivates the cooling fan 207 to reduce a surplus of power consumption.

As a second example, candidates for the operation states include a third state in which power is supplied from the third DC power supply 204 to the one or more heaters 120, and a fourth state in which the power supply path through the third DC power supply 204 is shut off. A fourth power value, which is the total consumed power of the heater power supply unit 200 in the fourth state, is lower than a third power value, which is the total consumed power of the heater power supply unit 200 in the third state. When one or more of the heaters 120a to 120c are set to be active, the CPU 211 selects the third state and causes the AC relay 201 to relay the power. On the other hand, when all of the heaters 120a to 120c are set to be inactive, the CPU 211 selects the fourth state and causes the AC relay 201 to shut off the power supply path in order to reduce a surplus of power consumption.

Of course, it is also conceivable to combine the first example and the second example. For example, the CPU 211 may select an operation state of the heater power supply unit 200 on the basis of the driving states of the heaters 120a to 120c as follows. Here, TH₃ is a third power threshold:
If P_{REQ}=0, then the third DC power supply 204 and the cooling fan 207 are deactivated
If 0<P_{REQ} <TH₃, then the third DC power supply 204 is activated and the cooling fan 207 is deactivated.
If TH₃≤P_{REQ}, then the third DC power supply 204 and the cooling fan are activated

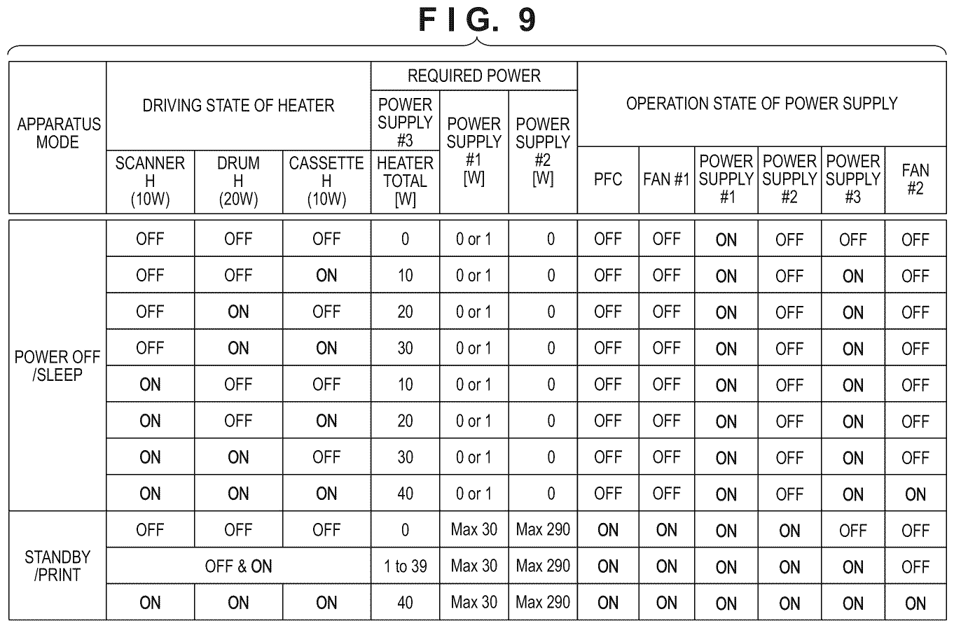

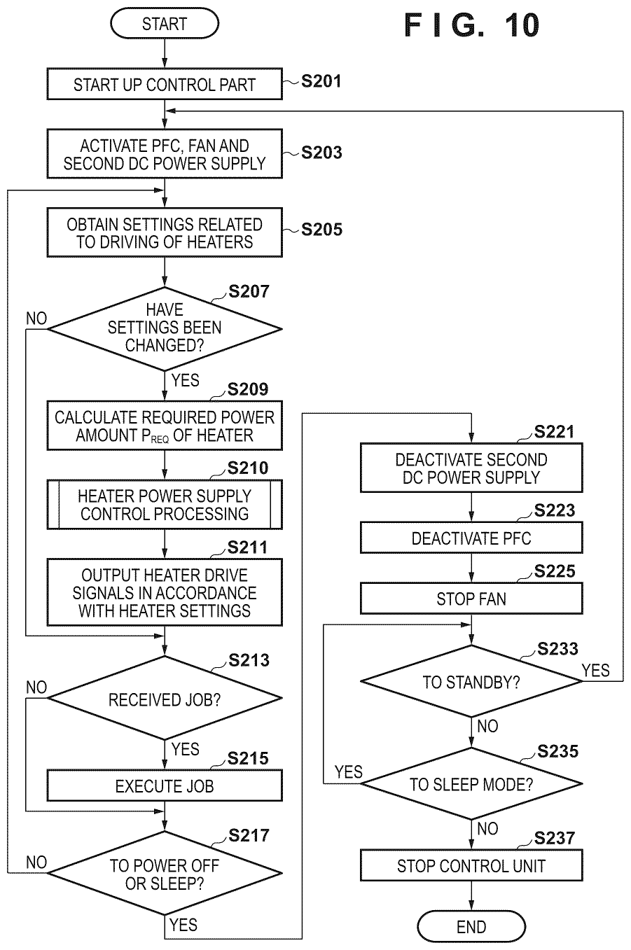

FIG. 9 is a mapping table that defines correspondence relationships between the driving states of the heaters 120 and the operation states of the power supply unit 100 and the heater power supply unit 200 according to the present practical example. The leftmost column of the mapping table indicates the operation mode of the multifunction peripheral 1. The operation mode of the multifunction peripheral 1 is one of “power off”, “sleep”, “standby”, and “print”.

The second to fourth columns from the left in the mapping table represent the driving state (“on” or “off”) of the scanner heater 120a, the drum heater 120b, and the cassette heater 120c, respectively. The required power amounts of the heaters 120a, 120b, and 120c are assumed to be 10 W, 20 W, and 10 W, respectively, as in the first practical example.

The fifth column in the mapping table indicates the total value of the required power amount required by the heater power supply unit 200, corresponding to the driving states of the heaters 120a to 120c in each row. The sixth column in the mapping table indicates the power amount supplied from the first DC power supply 104 to the control system, corresponding to the operation mode of the multifunction peripheral 1 in each row. The seventh column in the mapping table indicates the power amount supplied from the second DC power supply 105, corresponding to the operation mode of the multifunction peripheral 1 in each row. Regardless of the driving states of the heaters 120a to 120c, in the power off and sleep modes, the second DC power supply 105 is inactive, and the required power amount is therefore 0 [W]. In the standby mode and the print mode, power is supplied from the second DC power supply 105 to the drive system, and the required power amount thereof is a maximum of 290 [W].

The eighth to eleventh columns in the mapping table indicate how the CPU 211 selects an operation state of the power supply unit 100 with respect to the driving states of the heaters 120a to 120c in each row. In the present practical example, the PFC circuit 103 of the power supply unit 100 is controlled to be inactive before being powered on and in the sleep mode, and to be active in the standby mode and the print mode. The cooling fan 107 is also controlled to be inactive before being powered on and in the sleep mode, and to be active in the standby mode and the print mode. The first DC power supply 104 is always connected to the commercial power supply, and is active unless it is powered off. The second DC power supply 105 is also controlled to be inactive before being powered on and in the sleep mode, and to be active in the standby mode and the print mode.

The twelfth and thirteenth columns in the mapping table indicate how the CPU 211 selects an operation state of the heater power supply unit 200 with respect to the driving states of the heaters 120a to 120c in each row.

The twelfth column indicates whether the third DC power supply 204 is on or off. In the example illustrated in FIG. 9, when at least one of the heaters 120 is active, i.e., when the total value of the required power amount required by the heater power supply unit 200 is greater than zero, the third DC power supply 204 is active, regardless of the operation mode of the multifunction peripheral 1.

The thirteenth column indicates whether the cooling fan 207 is on or off. In the example illustrated in FIG. 9, the CPU 211 activates the cooling fan 207 when the total value of the required power amounts of the heaters 120a to 120c is 40 W or higher, and deactivates the cooling fan 207 when the total value of the required power amounts is less than 40 W. This threshold of 40Wcan correspond to the third power threshold TH₃ mentioned above.

As an example, when the cooling fan 207 is inactive, the maximum value of the power that the third DC power supply 204 is capable of outputting is less than 40 W. When the cooling fan 207 is active, the maximum value of the power that the third DC power supply 204 is capable of outputting is 40 W or higher. The mapping table in FIG. 9 assumes that the heater power supply unit 200 has such performance.

In the present practical example, one or both of the third DC power supply 204 and the cooling fan 207 are deactivated dynamically in accordance with the mapping table described above (or in accordance with a comparison of the required power amount with the power threshold). This makes it possible to eliminate wasteful power consumption and optimize the power consumption of the multifunction peripheral 1.

### <3-3. Flow of Processing>

FIG. 10 is a flowchart illustrating an example of a flow of state control processing that can be executed by the control unit 80 (e.g., the CPU 211) to control a power supply state in the multifunction peripheral 1 according to the present practical example.

The state control processing illustrated in FIG. 10 is started in response to the multifunction peripheral 1 being powered on. First, in step S201, the control unit 80 starts up, and commences the operations. In step S203, the control unit 80 outputs the PFC control signal SigP to the PFC circuit 103 to activate the PFC circuit 103. The control unit 80 also outputs the fan control signal SigF to the fan drive circuit 106 to start driving the cooling fan 107. The control unit 80 furthermore outputs the power control signal SigS to the second DC power supply 105 to activate the second DC power supply 105.

Next, in step S205, the control unit 80 obtains the heater settings received through the UI of the operation unit 70. Next, in step S207, the control unit 80 determines whether the heater settings have been changed since the previous calculation of the required power amount P_{REQ}. If the heater settings have been changed, the sequence moves to step S209.

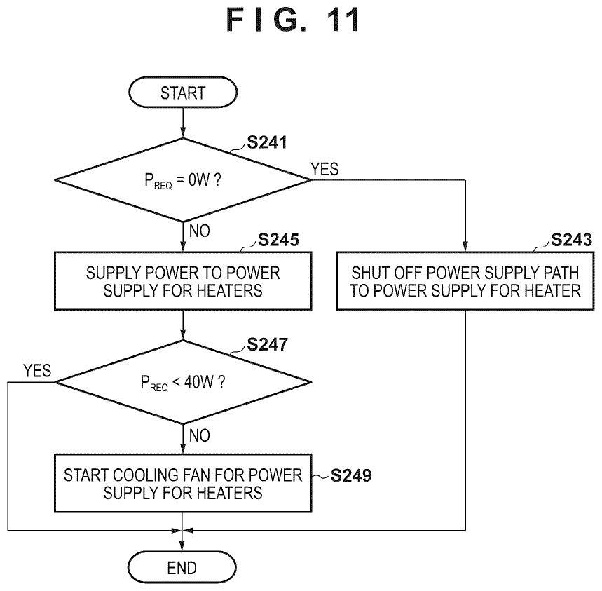

In step S209, the control unit 80 calculates the required power amount P_{REQ} on the basis of the heater settings obtained in step S205. For example, the control unit 80 can calculate the required power amount P_{REQ} by totaling the power amounts defined in advance for the heaters 120 set to be active. Next, in step S210, the control unit 80 sets the operation state of the heater power supply unit 200 by executing heater power supply control processing. The heater power supply control processing will be described in detail below with reference to FIG. 11. Then, in step S211, the control unit 80 outputs the drive signals Sig1, Sig2, and Sig3 to the heater drive circuits 130a, 130b, and 130c, respectively, in accordance with the heater settings.

If the heater settings have not been changed in step S207, steps S209 to S211 are skipped. In this case, the heater drive circuits 130a, 130b, and 130c drive the corresponding heaters 120a, 120b, and 120c in accordance with the drive signal values held in the respective latch circuits.

Next, in step S213, the control unit 80 stands by to receive a job. The operation mode of the multifunction peripheral 1 is the standby mode from step S205 to step S213. When a job is received in the standby mode, in step S215, the control unit 80 controls one or both of the printer unit 10 and the scanner unit 50 to execute the received job. The operation mode of the multifunction peripheral 1 in step S215 is the print mode (or the scanning mode, if a scan job is executed).

Next, in step S217, the control unit 80 determines whether the multifunction peripheral 1 should be powered off or transition to the sleep mode. For example, if an operation for turning the power off has been detected in the operation unit 70, the multifunction peripheral 1 is powered off. If an operation instructing a transition to the sleep mode is detected, or a predetermined length of time has passed without any operations being performed, the multifunction peripheral 1 transitions to the sleep mode. If the multifunction peripheral 1 is powered off or transitions to the sleep mode, the sequence moves to step S221. If the multifunction peripheral 1 remains in the standby mode, the sequence returns to step S205.

In step S221, the control unit 80 outputs the power control signal SigS to the second DC power supply 105 to deactivate the second DC power supply 105. Next, in step S223, the control unit 80 outputs the PFC control signal SigP to the PFC circuit 103 to deactivate the PFC circuit 103. Next, in step S225, the control unit 80 outputs the fan control signal SigF to the fan drive circuit 106 to stop the driving of the cooling fan 107.

Next, in step S233, the control unit 80 determines whether the multifunction peripheral 1 should be returned to the standby mode. For example, if any operation is detected in the operation unit 70, the multifunction peripheral 1 returns to the standby mode from the sleep mode. In this case, the sequence returns to step S203. If the condition for returning to the standby mode is not satisfied, in step S235, the control unit 80 determines whether the multifunction peripheral 1 should remain in the sleep mode or should be powered off. If the multifunction peripheral 1 should remain in the sleep mode, the sequence returns to step S233. If the multifunction peripheral 1 should be powered off, the sequence moves to step S237. In step S237, the control unit 80 stops operating, and the multifunction peripheral 1 turns into a state in which no power is supplied.

FIG. 11 is a flowchart illustrating an example of a detailed flow of the heater power supply control processing performed in step S210 of FIG. 10.

With reference to FIG. 11, first, in step S241, the control unit 80 determines whether the required power amount P_{REQ} calculated in step S209 is equal to zero. If P_{REQ} is equal to zero, in step S243, the control unit 80 outputs the power control signal SigR to the AC relay 201, and shuts off the power supply path to the third DC power supply 204, which is the power supply for heaters.

If P_{REQ} is greater than zero, in step S245, the control unit 80 outputs the power control signal SigR to the AC relay 201 to cause power to be supplied from the commercial power supply to the third DC power supply 204. Next, in step S247, the control unit 80 compares the required power amount P_{REQ} with the third power threshold TH₃, which is 40 [W].

If the required power amount P_{REQ} is lower than the third power threshold TH₃ (P_{REQ} <40 W; step S247-YES), the control unit 80 does not activate the cooling fan 207 for cooling the power supply for the heater (deactivates the cooling fan 207). If the required power amount P_{REQ} is equal to or higher than the third power threshold TH₃, in step S249, the control unit 80 outputs the fan control signal SigH to the fan drive circuit 206 to start driving the cooling fan 207.

The flowchart illustrated in FIG. 11 assumes the relationships between the driving states of the heaters 120a, 120b, and 120c and the operation states of the heater power supply unit 200 defined in the mapping table in FIG. 9. However, the relationships between the driving states of the one or more heaters 120 and the operation states of the heater power supply unit 200 are not limited to the examples described above. For example, the value of the third power threshold TH₃ may be different from that in the example described above.

In the present practical example too, the control unit 80 may store a mapping table associating each driving state of the heaters with the corresponding operation state of the heater power supply unit 200 in advance in the memory, and determine an operation state of the heater power supply unit 200 directly from the heater settings, without calculating the required power amount.

### 4. Variations

### <4-1. First Variation>

Many variations on the embodiments and two practical examples described above are conceivable. For example, at least one of the heaters 120 in the multifunction peripheral 1 may be supplied with AC power rather than DC power to be active.

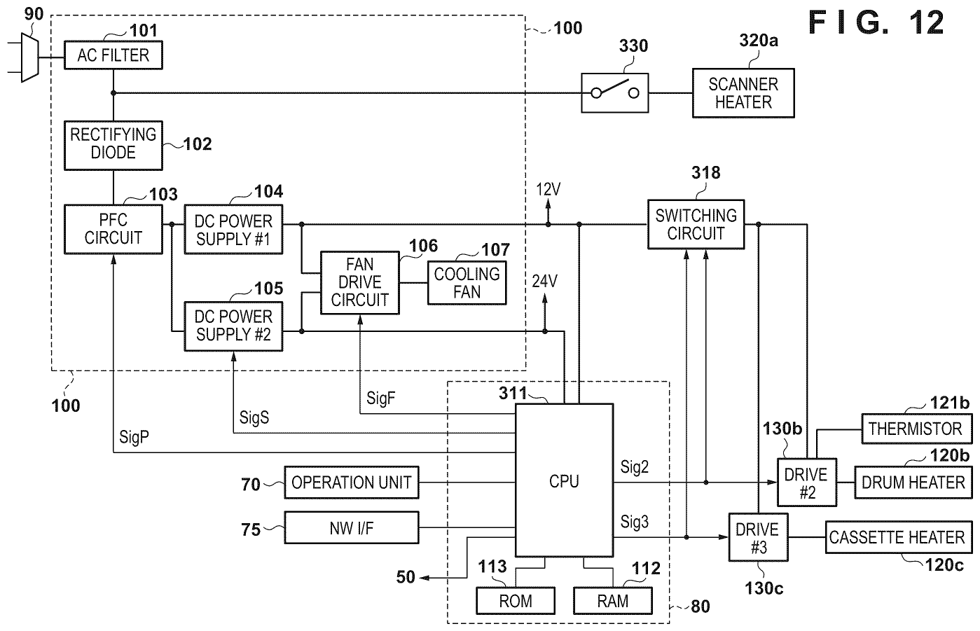

FIG. 12 is a block diagram illustrating an example of an overall configuration of heater-related circuitry according to a first variation. The configuration of the circuitry illustrated in FIG. 12 differs from the configuration of the circuitry according to the first practical example and illustrated in FIG. 2 in that an AC-powered scanner heater 320a and switch 330 are provided instead of the DC-powered scanner heater 120a and heater drive circuit 130a. In addition, in the present variation, the CPU 111 and the switching circuit 118 according to the first variation are replaced with a CPU 311 and a switching circuit 318.

The switching circuit 318 is a switching means that opens and closes a power supply path from the first DC power supply 104 to the drum heater 120b and the cassette heater 120c. When both of the drive signals Sig2 and Sig3 output from the CPU 311 to the heater drive circuits 130b and 130c, respectively, indicate that the corresponding heater is to be deactivated, the switching circuit 218 shuts off the supply of the DC power of 12V from the first DC power supply 104. When one or more of the drive signals Sig2 and Sig3 indicate that the corresponding heater is to be activated, the switching circuit 318 causes the first DC power supply 104 to supply the heater drive circuits 130b and 130c with the DC power.

The switch 330 is an opening and closing means that can be physically opened and closed by the user. One end of the switch 330 is connected to a branch point between the AC filter 101 and the rectifying diode 102, and the other end of the switch 330 is connected to the scanner heater 320a. When the switch 330 is closed by the user, AC power passing through the AC filter 101 is supplied to the scanner heater 320a. In other words, the switch 330 can open and close the power supply path from the commercial power supply to the scanner heater 320a. The scanner heater 320a is a resistive heating element disposed within the scanner unit 50. When the switch 330 is closed, the scanner heater 320a heats the optical system 52 using AC power supplied from the commercial power supply to prevent reading failures due to condensation.

In the present variation, the CPU 311 can obtain only the driving state settings of the drum heater 120b and the cassette heater 120c through a UI such as the heater settings screen 71 illustrated in FIG. 4. Accordingly, on the basis of the driving states of the two heaters 120, the CPU 311 selects an operation state of the power supply unit 100 such that a surplus of the total consumed power of the power supply unit 100 is reduced, and causes the power supply unit 100 to operate in the selected operation state.

### <4-2. Second Variation>

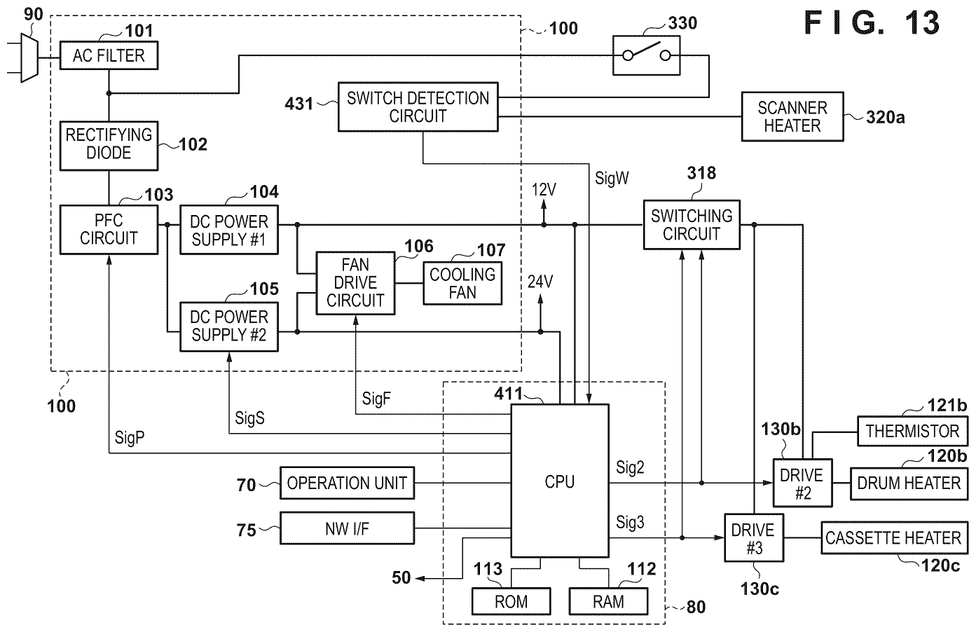

FIG. 13 is a block diagram illustrating an example of an overall configuration of heater-related circuitry according to a second variation. In the second variation too, at least one of the heaters 120 in the multifunction peripheral 1 is supplied with AC power rather than DC power to be active.

The configuration of the circuitry illustrated in FIG. 13 differs from the configuration of the circuitry illustrated in FIG. 12 in that a switch detection circuit 431 is disposed between the scanner heater 320a and the switch 330. In addition, in the present variation, the CPU 311 according to the first variation is replaced with a CPU 411.

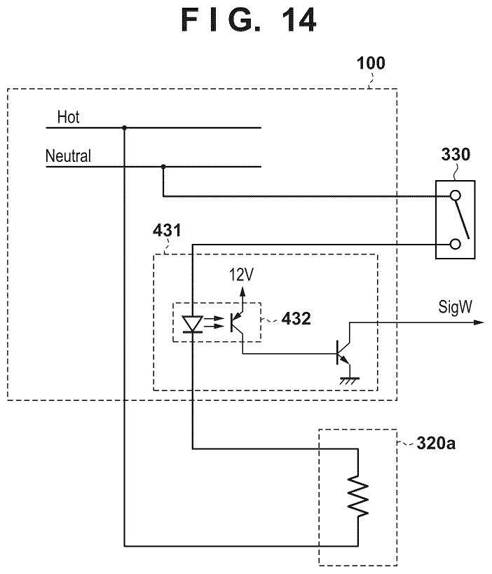

The switch detection circuit 431 detects an open/closed state of the switch 330, and outputs a detection signal SigW indicating the detected state to the CPU 411. FIG. 14 illustrates an example of a detailed configuration of the switch detection circuit 431. In the example illustrated in FIG. 14, the switch detection circuit 431 includes a photocoupler 432. The primary-side light-emitting element of the photocoupler 432 emits light when the switch 330 is closed by the user and current flows from the power supply unit 100 to the scanner heater 320a. The secondary-side light-receiving element detects the light and outputs the detection signal SigW to the CPU 411.

The CPU 411 can obtain the driving state settings of the drum heater 120b and the cassette heater 120c through a UI such as the heater settings screen 71 illustrated in FIG. 4. In addition, the CPU 411 can obtain the open/closed state of the switch 330 (or the driving state of the scanner heater 320a) on the basis of the detection signal SigW input from the switch detection circuit 431. For example, the CPU 411 may deactivate the power supply from the power supply unit 100 to the drum heater 120b and the cassette heater 120c when the switch 330 is open (when the power supply to the scanner heater 320a is shut off), regardless of the heater settings. Alternatively, the CPU 411 may cause the power supply unit 100 to supply power to the drum heater 120b and the cassette heater 120c when the switch 330 is closed (when power is supplied to the scanner heater 320a), regardless of the heater settings. Then, on the basis of the driving states of the three heaters 120, the CPU 411 selects an operation state of the power supply unit 100 such that a surplus of the total consumed power of the power supply unit 100 is reduced, and causes the power supply unit 100 to operate in the selected operation state.

In the two variations described above as well, when some of the heaters are set to be inactive (e.g., through an input made on a screen or operating a physical switch), the power consumption of the power supply unit can be optimized to enhance the energy conservation effect.

### 5. Conclusion

Thus far, embodiments of the technology according to the present disclosure, as well as various practical examples and variations thereof, have been described with reference to FIGS. 1 to 14. In the embodiments described above, the image-processing apparatus includes one or more heaters and a power supply unit including at least one direct current power supply, and the power supply unit operates in one of a plurality of operation states each having a different total consumed power. The one or more heaters are driven using power supplied from the at least one direct current power supply. A controller of the image-processing apparatus causes, on the basis of a driving state of the one or more heaters, the power supply unit to operate in an operation state selected to reduce a surplus of the total consumed power. According to this configuration, when some heaters are not driven, excess power can be prevented from being consumed, and the energy conservation effect can be enhanced. In addition, when many or all heaters are to be driven, a circuit that contributes to improving the power capacity or power supply efficiency of the power supply unit can be activated to ensure a stable power supply.

### 6. Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-024826, filed on Feb. 21, 2024 which is hereby incorporated by reference herein in its entirety.

What is claimed is:

1. An image-processing apparatus comprising:
one or more heaters;
a power supply unit including at least one direct current power supply, the power supply unit being configured to operate in one of a plurality of operation states having respective different total consumed powers;
one or more drive circuits configured to drive the one or more heaters, respectively, using power supplied from the at least one direct current power supply; and
a controller configured to control, on the basis of a driving state of the one or more heaters, the power supply unit to operate in an operation state selected such that a surplus of the total consumed power is reduced.

2. The image-processing apparatus according to claim 1,
wherein the power supply unit includes at least one circuit configured to be activated and consume power in accordance with control by the controller, and
the plurality of operation states of the power supply unit include:
a first state in which the at least one circuit is active and the total consumed power of the power supply unit is a first power value; and
a second state in which the at least one circuit is active and the total consumed power of the power supply unit is a second power value lower than the first power value.

3. The image-processing apparatus according to claim 2,
wherein the one or more heaters include a plurality of heaters, and
the controller is configured to:
control the power supply unit to operate in the first state when a first number of the heaters among the plurality of heaters are driven; and
control the power supply unit to operate in the second state when a second number of the heaters among the plurality of heaters are to be driven, the second number being smaller than the first number.

4. The image-processing apparatus according to claim 2,
wherein the controller is configured to:
control the power supply unit to operate in the first state when at least one heater among the one or more heaters is driven; and
control the power supply unit to operate in the second state when none of the one or more heaters is driven.

5. The image-processing apparatus according to claim 2,
wherein the at least one direct current power supply is configured to convert alternating current voltage from a commercial power supply into direct current voltage to supply power with the direct current voltage, and
the at least one circuit includes a power factor correction circuit configured to correct a power factor in the at least one direct current power supply.

6. The image-processing apparatus according to claim 2,
wherein the at least one circuit includes a drive circuit configured to drive a cooling unit that cools the at least one direct current power supply.

7. The image-processing apparatus according to claim 1,
wherein the at least one direct current power supply includes:
a first direct current power supply configured to supply power to the one or more heaters; and
a second direct current power supply configured to supply power to the controller, and
the plurality of operation states of the power supply unit include:
a third state in which power is supplied from the first direct current power supply to the one or more heaters, and the total consumed power of the at least one direct current power supply is a third power value; and
a fourth state in which a power supply path passing through the first direct current power supply is shut off, and the total consumed power of the at least one direct current power supply is a fourth power value lower than the third power value.

8. The image-processing apparatus according to claim 1,
wherein the controller is configured to control the power supply unit to operate in the operation state selected on the basis of a comparison between (i) a required power amount determined on the basis of the driving state of the one or more heaters and (ii) a predetermined threshold.

9. The image-processing apparatus according to claim 8,
wherein the one or more heaters include a plurality of heaters,
the image-processing apparatus further comprises a memory configured to store a power amount required when driving each of the plurality of heaters, and
the controller is configured to determine the required power amount by totaling the power amounts stored in the memory for heaters set to be active.

10. The image-processing apparatus according to claim 8,
wherein the controller is configured to determine the required power amount on the basis of (i) the driving state of the one or more heaters and (ii) a power consumed by a component, aside from the one or more heaters, that depends on an operation mode of the image-processing apparatus.

11. The image-processing apparatus according to claim 1, further comprising:
a receiving unit configured to receive a setting as to whether to activate each of the one or more heaters,
wherein the one or more drive circuits are configured to drive the one or more heaters in accordance with the setting received by the receiving unit.

12. The image-processing apparatus according to claim 1, further comprising:
a further heater configured to be driven using power supplied from an alternating current power supply; and
a switch capable of opening and closing a power supply path from the alternating current power supply to the further heater,
wherein the controller is configured to control the driving state of the one or more heaters on the basis of an open/closed state of the switch.

13. The image-processing apparatus according to claim 1,
wherein the image-processing apparatus includes an image-forming apparatus configured to form an image on a sheet, and
the one or more heaters include a heater for heating a container unit configured to contain a sheet bundle.

14. The image-processing apparatus according to claim 1,
wherein the image-processing apparatus includes an image-forming apparatus configured to form an image on a sheet, and
the one or more heaters include a heater for heating an image-forming unit.

15. The image-processing apparatus according to claim 1,
wherein the image-processing apparatus includes a reading apparatus configured to optically read a document, and
the one or more heaters include a heater for heating an optical system of the reading apparatus.
